(19) United States
(12) Patent Application Publication
(10) Pub. No.: US 2023/0131508 A1
(43) Pub. Date: Apr. 27, 2023

(54) APPARATUS AND PROCESS FOR THERMAL TREATMENT OF MINERAL SOLIDS

(71) Applicants: thyssenkrupp Industrial Solutions AG, Essen (DE); thyssenkrupp AG, Essen (DE)

(72) Inventors: Guido GRUND, Werl (DE); Eugen WAGNER, Werl (DE); Christian BRINKMANN, Bielefeld (DE)

(73) Assignees: thyssenkrupp Industrial Solutions AG, Essen (DE); thyssenkrupp AG, Essen (DE)

(21) Appl. No.: 17/791,877

(22) PCT Filed: Jan. 5, 2021
(86) PCT No.: PCT/EP2021/050073

§ 371 Date: Jul. 8, 2022

(30) Foreign Application Priority Data
Jan. 9, 2020 (BE) 2020/5011
Jan. 9, 2020 (DE) 10 2020 200 186.3

(51) Int. Cl. C04B 20/04; C04B 7/36; F27B 7/20

(52) U.S. Cl. CPC C04B 20/04; C04B 7/36; F27B 7/20; C04B 2103/0096

(57) ABSTRACT

An apparatus for thermally treating mineral solids includes a preheater, a separating apparatus arranged at an outlet of an entrained flow reactor, and a thermal treatment zone at an outlet of a gas stream of the separating apparatus, with an outlet of the treatment zone being connected to an inlet of the preheater for the gas stream. A process may involve preheating a mineral material, thermally treating the mineral material in an entrained flow reactor in a reducing atmosphere for reducing coloring metal compounds, separating a solid/gas mixture from the entrained flow reactor in a separating apparatus, oxidizing reducing constituents of a gas from the separating apparatus in a thermal treatment zone between the separating apparatus and the preheater via supplied oxygen, and supplying gas emerging from the thermal treatment zone to the preheater and thereby utilizing thermal energy recovered in the thermal treatment zone by transfer to mineral material

The invention relates to an apparatus for producing color-optimized cement clinker from starting materials comprising natural clays.

Cement is a hydraulically hardening construction material that consists of a mixture of finely ground, nonmetallic, inorganic constituents. It is produced in general by jointly grinding the fired cement clinker with gypsum and, optionally, further supplementary cementing materials (SCM).

The principal raw material for clinker production is limestone, which is mined in quarries, precomminuted in crushers, and conveyed to the cement works. After grinding and drying, it is mixed with other ground components, such as sand, clay or iron ore to give a raw meal. This raw meal is fired in a rotary kiln at temperatures above about 1450° C. to give clinker, which is then cooled in a cooler to a temperature of preferably below 200° C. The resultant granules are subsequently ground in a mill, a ball mill or roll mill, for example, together with gypsum or anhydrite, to give cement.

Because of the massive growth in demand for cement in developing countries, the share of cement production among the total anthropogenic CO₂ emissions has risen steadily and is estimated by some sources to be about 10% or about 6% of the total anthropogenic greenhouse gases. This has taken place in spite of the important improvements in production efficiency and the efforts on the part of the cement industry to reduce emissions since the 1970s (Karen L. Scrivener, Vanderley M. John, Ellis M. Gartner; Eco-efficient cements: Potential economically viable solutions for a low-CO₂ cement-based materials industry, United Nations Environment Programme (2017)). Given that more than about half of the CO₂ emissions associated with clinker production are caused by the limestone raw material, reducing the clinker content (clinker factor) by replacement with a different component can make a substantial contribution toward reducing these emissions.

Cement substitutes or SCMs proposed have included, for example, calcined clay or else naturally heat-treated pozzolans. A calcined clay is suitable, naturally occurring clay which has been activated thermally at appropriate temperature to give it pozzolanic properties. Clays suitable for this purpose generally contain clay minerals in the form of 1-layer and/or 2-layer phyllosilicates, as for example kaolinite, illite or montmorillonite. Additionally these clays may also contain accompanying minerals, such as quartz, feldspars, calcite and dolomite, for example, but also metal oxides and hydroxides or else, specifically, iron hydroxides. Naturally occurring clays are usually iron-rich and/or contain other coloring metals, and so the conventional calcining is accompanied for example by a reddish discoloration of the product. While this coloration has no effect on the strength and other building-material properties, it is nevertheless rated as undesirable by plant operators and building-material customers. At the present point, however, the acceptance of a building material by the end users, i.e., the market potential of the calcined clays and therefore the potential for possible CO₂ savings, are substantially dependent on their color.

Fine-grained mineral solids, such as clay, for example, are calcined conventionally in rotary kilns or multilevel grating kilns. This ensures that a low temperature is maintained during a residence time needed for the treatment in this process. For instance U.S. Pat. No. 4,948,362 A describes a process for calcining clay wherein to increase the luster and to minimize the abrasiveness, kaolin clay is treated using a hot calcining gas in a multilevel grating kiln. The calcined clay powder is separated from the calcining kiln offgas in an electrostatic filter and processed further to give the desired product.

Against the background of the global reduction in CO₂ emissions, substances which contribute to development of strength in cement and/or in concrete and whose production releases less CO₂ than in a cement clinker firing operation are increasingly attracting focus. Natural clays and/or zeolites which are subjected to a thermal treatment (calcination) appear to possess a highly promising potential in this regard.

Hence DE 10 2008 020 600 A1 discloses a process for calcining clay or gypsum wherein the solids are passed through a flash reactor in which they are brought into contact at a temperature of 450 to 1500° C. with hot gases. The solids are subsequently passed through a residence time reactor at a temperature of 500 to 850° C. and then optionally supplied to a further treatment stage.

DE 10 2008 031 165 A1 discloses using the cement generation plant itself for producing calcined clay, where at least two preheating lines are provided, with one being used to preheat the clay and the other to heat clinker raw material. Hot gases are generated in a combustion chamber, serve to calcine the clay, and are guided through the preheating stages in countercurrent to the solids. However, the clay used in these processes has a high kaolinite content of more than 40 wt % and is very expensive, and consequently cannot be used to produce an economically marketable clinker substitute.

DE 690 10 646 T2 relates to ceramic microspheres produced from bauxite and to the use of these microspheres as reinforcing materials and functional fillers. The bauxite proposed as a source of the microspheres comprises 55% to 63% aluminum oxide and 7% to 13% silicon dioxide, the silicon dioxide being present substantially in the form of kaolinite. The mineralogy typically comprises 30% to 50% gipsite with 15% to 45% boehmite, 16% to 27% kaolinite with less than 0.2% quartz, and 6% to 10% oxides of iron and 3% to 5% titanium oxides. On a laboratory scale, calcining takes place at about 900° C. in order to expel water. The kiln is subsequently heated to about 1300° C., after which the material is cooled and then rapidly brought to a sintering temperature between 1300° C. and 1600° C. and fired.

In U.S. Pat. No. 3,941,872 A, clay is first heat-treated under reducing conditions and subsequently under oxidizing conditions, to produce calcined clay having a desired pallor.

DE 10 2011 014 498 A1 discloses a process for producing a clinker substitute for use in cement production, by first calcining a clay, comminuted to a particle size of <2 mm, at a temperature of 600 to 1000° C. A subsequent reducing treatment at temperatures of 600 to 1000° C. with a CO-containing gas results in a change in color of the red calcined clay into gray calcined clay.

The problem addressed in WO 2012/082683 A1 was that of producing synthetic pozzolans having desired color properties, more particularly a light gray shade. The solution specified is the heating of a raw material suitable for forming an amorphous aluminum silicate to an activation temperature at which the raw material is converted into synthetic pozzolan. The synthetic pozzolan is subsequently cooled from the activation temperature to a temperature at which it is stable in color. This cooling operation takes place at least partly under reducing conditions. The result obtained is then a pozzolan having the desired gray shade.

DE 10 2014 116 373 A1 discloses a process for heat-treating natural clays and/or zeolites, where trivalent iron is converted at least partly into divalent iron and/or divalent iron present in the starting material remains in this valence state.

U.S. Pat. No. 9,458,059 B2 discloses a process for producing synthetic pozzolan wherein the cooling atmosphere may comprise CO.

DE 10 2015 101 237 A1 discloses a process for heat-treating fine-grained or pulverulent material.

For color optimization during the thermal treatment, such as during the calcination, therefore, it is common practice to add reducing gas components, examples being carbon monoxide (CO), hydrogen (H₂), carbon and/or hydrocarbons. These components act reducingly on the metal oxide compounds in the clays and reduce them at least partly, thereby reducing or preventing unwanted reddening of the product and/or getting the product a gray coloration.

In order to enable effective and more extensive color optimization, it is necessary for reducing gas components to be present also still at the end of the operating step of thermal treatment, such as the calcination and color optimization, for example. These reducing gas components are therefore present in the plant offgas. However, they cannot simply be released to the environment. The plant offgas therefore has to undergo aftertreatment. This is typically accomplished by downstream combustion, with the energy generated as a result being recovered, in heat exchangers, for example. The combustion must also be carried out at sufficiently high temperatures and for a sufficiently long time to ensure that no harmful substances are released to the environment. For this purpose, typically, the further addition of fuel products is necessary. This process, however, is complicated and the energy produced can be utilized only to a limited extent with acceptable cost and complexity.

It is an object of the invention to provide an apparatus for thermally treating clays with color optimization wherein harmful components in the offgas of the operating stage with color optimization, such as carbon monoxide or hydrocarbons, are reliably removed and at the same time the energy generated in this stage is introduced with maximum efficiency into the overall operation.

This object is achieved by the apparatus having the features specified in claim 1 and also by the process having the features specified in claim 9. Advantageous developments are apparent from the dependent claims, the description hereinafter, and the drawings.

The apparatus of the invention serves for thermally treating mineral solids, especially natural clays. The solids in question are more particularly those whose constituents include iron, manganese, chromium or other coloring metal compounds, which may be present as independent mineral phases and/or intercalated in mineral phases of the clay. The apparatus comprises at least a preheater and an entrained flow reactor. The entrained flow reactor is operated with an atmosphere which is reducing for coloring metal compounds, more particularly metal chalcogenides, more particularly metal oxides, metal hydroxides, metal halides and also compounds with a variety of these anions, the purpose of the atmosphere being to optimize the color of the raw materials used in the course of the thermal treatment. The entrained flow reactor is designed for example and preferably for the use of hydrogen, carbon monoxide, hydrocarbons, natural gas, oil or coal. Arranged at the outlet of the entrained flow reactor is a separating apparatus, in which the solid is separated largely from the gas phase.

The color optimization is served by the entrained flow reactor, in which preferably the thermal treatment, more particularly the thermal activation of the mineral solid, more particularly of the clay, may likewise take place. The color optimization may also take place downstream of the thermal treatment. The entrained flow reactor comprises a reducing agent supply line. The reducing agent supply line may supply a reducing agent, hydrogen for example, directly via a supply apparatus. Alternatively or additionally the reducing agent supply line may also be a combustion apparatus in which more fuel is supplied than there is oxygen present for the combustion operation. An effect of this is to generate reducing constituents in situ, such as carbon monoxide. Similarly, for example, hydrocarbon compounds, methane for example, which is supplied in excess, may also react directly with the metal compounds and so reduce them. In that case the reducing agent supply line supplies the reducing agent directly via a supply apparatus, but at the same time is also a combustion apparatus.

In order to process natural clays into a product which as far as possible is colorless, the entrained flow reactor comprises, for example, an atmosphere which is reducing for coloring metal oxides. A “colorless product” in the sense of the invention means that the product exhibits no coloredness, a red coloration for example, but instead has a white or gray appearance. A “reducing atmosphere” in the sense of the invention means that gas constituents or fuel constituents which are reducing—in particular and preferably the gas constituents or fuel constituents are not fully burnt out—i.e., for example, the gas still contains hydrocarbons, carbon monoxide or hydrogen or still contains oil or coal but contains no or very little oxygen. These constituents may already be present in the gas phase supplied to the entrained flow reactor, may be added specifically to the gas phase, or may be generated by a specifically incomplete combustion of natural gas, oil, coal, biomass or other fuels for example in the burner or else in the entrained flow reactor. As a result, the gas stream departing the downstream separating apparatus contains these reducing compounds, i.e., hydrogen, carbon monoxide and/or hydrocarbons, in concentrations which are considered to be environmentally harmful. As well as the reducing compounds (reducing constituents), the gas stream of course contains inert components, more particularly nitrogen (N₂) and carbon dioxide (CO₂).

At the outlet of the gas stream of the separating apparatus, therefore, a thermal treatment zone is arranged in which, for example and in particular, the constituents incompletely burnt out are burnt out approximately completely. The outlet of the thermal treatment zone is connected to the inlet for the gas stream of the preheater. In the thermal treatment zone, of course, only the reducing constituents are oxidized; the inert constituents (components) remain unchanged.

An advantage of arranging the thermal treatment zone at this location is that at this point in time the gases have a comparatively high temperature, of 800° C. or more, for example. At this point in time, however, the gases do not normally exceed a temperature of 1200° C. The gases therefore have roughly the temperature needed for reliable combustion of these substances which are not to be emitted to the environment. As a result it is possible to avoid the offgas stream, after dust removal, having to be heated to such a high temperature again, with the subsequent need for this heat to be recovered again. At the same time, as a result, the heat energy recovered is recovered at this high temperature level and utilized and delivered directly to the flow of the raw material in the preheater.

For the reaction of the reducing constituents still present in the gas stream, the thermal treatment zone comprises at least one second supply apparatus for oxygen. In the thermal treatment zone, therefore, the reducing agent supplied by the reducing agent supply line reacts with the oxygen supplied in the thermal treatment zone.

Preferred clays are those which contain clay minerals in the form of one-layer and/or two-layer phyllosilicates, as for example kaolinite, illite or montmorillonite. Additionally these clays may also contain accompanying minerals, such as, for example, quartz, feldspars, calcite and dolomite, but also metal oxides and metal hydroxides, or else, specifically, iron hydroxides.

In another embodiment of the invention, the apparatus additionally comprises, for example, a drying unit which initially dries the raw material, where the raw material to be processed includes material whose moisture content is too high. Additionally, for example, the apparatus may further comprise a comminuting apparatus, such as a mill, for example, for further comminution of raw material, where this raw material is not actually supplied in the required fineness or may have a tendency to aggregate in storage. Additionally, moreover, the apparatus may comprise a cooling apparatus which cools the product emerging from the entrained flow reactor. For example, this cooling may preferably be designed in two stages. By way of example and preferably, the cooling, at least partly, may take place under inert conditions.

In another embodiment of the invention, the apparatus is a constituent of a plant for producing cement clinker. The plant for producing cement clinker may further comprise, for example, a drying unit which initially dries the raw material, where the raw material to be processed includes material whose moisture content is too high. Additionally the plant for producing cement clinker may further comprise, for example, a comminuting apparatus, such as a mill, for further comminution of raw material, where said material is not actually supplied in the required fineness or may have a tendency to aggregate in storage. Furthermore, the plant for producing cement clinker may further comprise a cooling apparatus which cools the product emerging from the entrained flow reactor. This cooling is designed in two or more stages, for example, and at least in the first cooling stage the cooling proceeds under inert or reduced conditions, in other words without or with a negligibly small oxygen fraction in the gas surrounded by the product.

In another embodiment of the invention, the thermal treatment zone has a cylindrical design.

In another embodiment of the invention, the thermal treatment zone is in a tubular arrangement vertically above the separating apparatus. In order to realize the necessary residence time in the thermal treatment zone, and in order to achieve reliable combustion of the reducing compounds, the thermal treatment zone has a length for example of 5 m to 50 m, preferably of 10 m to 40 m. With the flow velocities customary on the part of the gases for plants of this kind, a residence time of a few seconds is enabled accordingly. A result of this is reliable combustion of the reducing compounds.

In another embodiment of the invention, the thermal treatment zone comprises at least one first supply apparatus for a fuel. The nature of the first supply apparatus is dependent on the nature of the fuel. The fuel used may comprise solid fuels, liquid fuels and also gaseous fuels. An example of a gaseous fuel is natural gas; an example of a liquid fuel is oil; and an example of a solid fuel is coal dust. The thermal treatment zone may comprise multiple first supply apparatuses for a fuel. This enables greater uniformity.

In another embodiment of the invention, the thermal treatment zone comprises at least one second supply apparatus for oxygen. The oxygen can be supplied in the form of pure oxygen, but this is usually avoided for reasons of cost. The oxygen may be supplied in the form of air. As a further oxygen source it is also possible to use offgas, which does have a reduced oxygen content but on the other is already heated. The thermal treatment zone may comprise multiple second supply apparatuses for oxygen. This enables greater uniformity.

In another embodiment of the invention, the second supply apparatus is configured for supplying oxygen under increased pressure. The effect of this is more effective mixing in the interior of the thermal treatment zone.

In another embodiment of the invention, the thermal treatment zone comprises a second supply apparatus with which the oxygen and/or air is supplied to the thermal treatment zone under elevated pressure relative to the internal pressure of the thermal treatment zone, so as to ensure mixing of the supplied oxygen with the gas within the thermal treatment zone. The elevated pressure may be generated for example and in particular by means of a fan or compressor. Air may also be provided in the form of compressed air.

With particular preference, the thermal treatment zone comprises a first supply apparatus for a fuel and a second supply apparatus for oxygen. This is the best way of reliably establishing the temperature conditions for the safe and reliable combustion of the reducing gases. It is additionally possible, for example, to use ambient air at ambient temperature, with the required heating energy being provided by the fuel.

In another embodiment of the invention, the preheater is designed as a cyclone preheater, more particularly as an at least two-stage cyclone preheater.

In a further aspect, the invention relates to a process for thermally treating mineral material, more particularly for producing naturally heat-treated pozzolans. The mineral material selected is a material which comprises coloring metal compounds, more particularly iron compounds and/or chromium compounds. The process comprises the following steps:
a) preheating a mineral material in a preheater,
b) transferring the mineral material heated in the preheater to the entrained flow reactor,
c) thermally treating the mineral material in an entrained flow reactor in a reducing atmosphere for reducing the coloring metal compounds during the thermal treatment,
d) separating the solid/gas mixture coming from the entrained flow reactor in a separating apparatus.

In accordance with the invention the process additionally comprises the following steps:
e) oxidizing the reducing constituents of the gas coming from the separating apparatus in a thermal treatment zone by means of oxygen supplied in the thermal treatment zone,
f) supplying the gas emerging from the thermal treatment zone to the preheater. By this means the thermal energy recovered in the thermal treatment zone is utilized and is transferred to the mineral material in the preheater.

An advantage of the process of the invention is that the energy recovered through the oxidation of the reducing constituents of the gas stream is delivered to the raw material directly and immediately in the preheater and is therefore used entirely within the operation.

The reducing component of the reducing atmosphere in step c) comprises, for example and preferably, carbon monoxide (CO), hydrogen (H₂), carbon and/or hydrocarbons. The atmosphere typically also comprises inert gas, more particularly nitrogen (N₂) and carbon dioxide (CO₂). The reducing components serve in particular to reduce coloring metal compounds in the mineral solid to a low oxidation state and so to optimize the coloring.

The solid/gas mixture which comes from the entrained flow reactor is separated preferably in a separating apparatus which is configured as a cyclone separator.

In another embodiment of the invention, the oxidizing in step e) takes place at a temperature of 700° C. to 1000° C. and over a period of 1 s to 10 s.

In another embodiment of the invention, in step e) a fuel is supplied to the gas. The nature of the fuel may be different. The fuel used may comprise solid fuels, liquid fuels and gaseous fuels. An example of a gaseous fuel is natural gas; an example of a liquid fuel is oil; and an example of a solid fuel is coal dust.

In another embodiment of the invention, in step e) oxygen is supplied to the gas. The oxygen may be supplied in the form of pure oxygen, though this is usually avoided on grounds of cost. The oxygen may be supplied in the form of air. Another oxygen source that can be used is offgas which, though having a reduced oxygen content, is nevertheless already heated. This gas supply may take place at increased pressure.

In another embodiment of the invention, the flow of the mineral material is guided around the thermal treatment zone.

The apparatus of the invention is elucidated in more detail below, using an exemplary embodiment as represented in the drawings.

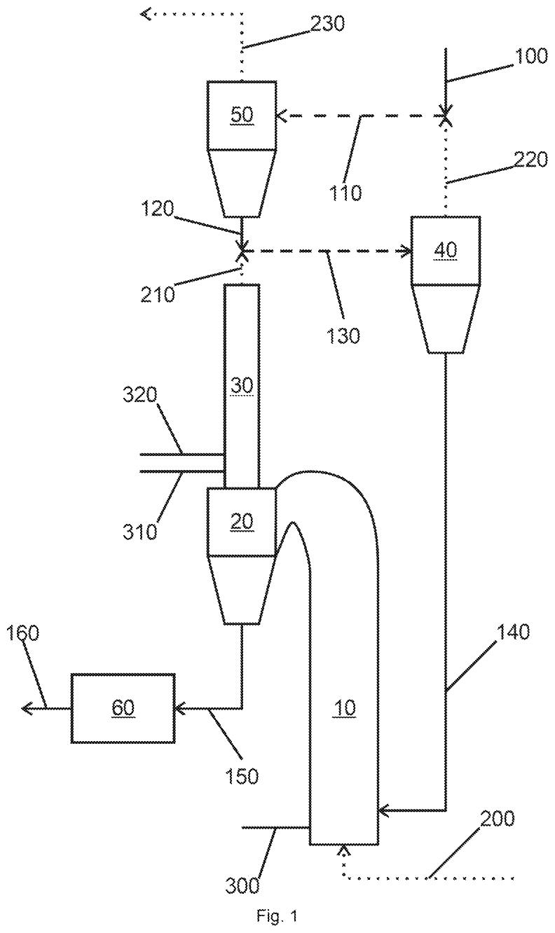

FIG. 1 schematic view of the apparatus

In FIG. 1 the apparatus is shown illustratively. The apparatus comprises an entrained flow reactor 10, a separating apparatus 20, a thermal treatment zone 30, a first preheating cyclone 40, a second preheating cyclone 50, and a cooler 60.

At the start the raw material 100 is added. This material may, for example, have been dried and ground beforehand, before being introduced here into the apparatus. The raw material 100 is mixed with the slightly cooled gas stream 220, which comes from the first preheating cyclone 40. In the first preheating stage 110, the gas stream transfers the heat to the raw material. In the second preheating cyclone 50, the gas stream is separated from the solid. The aforesaid raw material 120 is mixed subsequently with the combustion gases 210 coming from the thermal treatment zone 30. In the second preheating stage 130 the gas stream gives up its heat to the raw material.

Subsequently, in the first preheating cyclone 40, the solid is again separated from the gas stream. The heated raw material 140 is supplied to the entrained flow reactor 10. In the entrained flow reactor 10 the raw material is converted thermally to give the product, and the product undergoes color optimization. For the color optimization, for example, carbon, hydrogen or natural gas is supplied via the reducing agent supply line 300. Subsequently in the separating apparatus 20, which is likewise designed as a cyclone, the solid is separated from the gas stream. The hot product 150 is passed to the cooler 60, where it is cooled and can be withdrawn as product 160. Cooler 60 may for example have a multistage design, more particularly a two-stage design; for example, the cooler may be or may comprise a fluidized bed cooler, a moving bed cooler, a cooling coil, a cyclone cooler, a fluid-bed cooler, or a drum cooler.

The gas stream 200 is supplied to the entrained flow reactor 10. A burner here may ensure the necessary temperature, for example. This burner may be operated, for example, so that it generates carbon monoxide (CO), for example, and so introduces reducing constituents into the gas stream. Hydrocarbons or hydrogen, for example, in the form of unreacted combustion gases, for example, may also be introduced in this way. Alternatively or additionally a further burner may be arranged. The gas stream carries the solid through the entrained flow reactor 10 and is separated from the solid in the separating apparatus 20. From the separating apparatus 20, the gas stream, in the example shown, enters directly and immediately into the thermal treatment zone 30, which is arranged vertically above the separating apparatus 20. In the example shown, the thermal treatment zone 30 comprises a first supply line for fuel 310 and a second supply line for oxygen 320. As a result there is complete combustion of the reducing constituents contained in the gas stream—for example, hydrogen (H₂), carbon monoxide (CO) or hydrocarbons. At the same time the gas stream is preferably heated by the combustion energy liberated, or heat losses, owing for example to emission to the environment or to the supplying of further components, especially cold components, air for example, are compensated. The gas stream emerges as hot combustion gas 210 and is mixed with the preheated raw material 120 and passed to the second preheating stage 130. The gas stream is subsequently separated from solid in the first preheating cyclone 40, and the slightly cooled gas stream 220 is mixed with the raw material 100 and passed into the first preheating stage 110, in which the residual heat of the gas stream is transferred to the solid. The solid is subsequently removed from the gas stream in the second preheating cyclone 50. Gas stream 230 emerges, cooled, from the second preheating cyclone 50.

### REFERENCE SYMBOLS

10 Entrained flow reactor
20 Separating apparatus
30 Thermal treatment zone
40 First preheating cyclone
50 Second preheating cyclone
60 Cooler
100 Raw material
110 First preheating stage
120 Preheated raw material
130 Second preheating stage
140 Heated raw material
150 Hot product
160 Product
200 Gas stream
210 Combustion gases
220 Slightly cooled gas stream
230 Cooled gas stream
300 Reducing agent supply line
310 Fuel
320 Oxygen

1.-12. (canceled)

13. An apparatus that is configured to thermally treat mineral solids, the apparatus comprising:
a preheater;
an entrained flow reactor comprising a reducing agent supply line;
a separating apparatus disposed at an outlet of the entrained flow reactor; and
a thermal treatment zone disposed at an outlet of a gas stream of the separating apparatus, wherein the thermal treatment zone comprises a second supply apparatus for oxygen, wherein the thermal treatment zone is configured for reacting a reducing agent supplied by the reducing agent supply line with the oxygen, wherein an outlet of the thermal treatment zone is connected to an inlet of the preheater for a gas stream.

14. The apparatus of claim 13 wherein the reducing agent supply line is a supply apparatus for the reducing agent.

15. The apparatus of claim 13 wherein the reducing agent supply line is a combustion apparatus that supplies more fuel than there is oxygen present, the combustion apparatus being configured to generate reducing constituents.

16. The apparatus of claim 13 comprising a transfer apparatus for the mineral solids, which are heated in the preheater, for transfer from the preheater to the entrained flow reactor.

17. The apparatus of claim 13 wherein the thermal treatment zone is cylindrical.

18. The apparatus of claim 13 wherein the thermal treatment zone is tubular and extends vertically above the separating apparatus.

19. The apparatus of claim 13 wherein the thermal treatment zone includes a first supply apparatus for a fuel.

20. The apparatus of claim 13 wherein the preheater is a cyclone preheater.

21. The apparatus of claim 13 wherein the preheater is a two-stage cyclone preheater.

22. A process for thermally treating mineral material that comprises iron compounds and/or chromium compounds, the process comprising:
preheating a mineral material in a preheater;
transferring the mineral material that is heated in the preheater to an entrained flow reactor;
thermally treating the mineral material in the entrained flow reactor in a reducing atmosphere for reducing coloring metal compounds during the thermal treatment;
separating a solid/gas mixture coming from the entrained flow reactor in a separating apparatus;
oxidizing reducing constituents of a gas coming from the separating apparatus in a thermal treatment zone between an outlet of a gas stream of the separating apparatus and an inlet of the preheater for the gas stream by way of supplied oxygen; and
supplying the gas emerging from the thermal treatment zone to the preheater and thereby utilizing thermal energy recovered in the thermal treatment zone by transfer to the mineral material.

23. The process of claim 22 wherein the oxidizing occurs at a temperature of 700° C. to 1000° C. and over a period of 1 s to 10 s.

24. The process of claim 22 comprising supplying a fuel to the gas in the oxidizing step.

25. The process of claim 22 comprising guiding a flow of the mineral material around the thermal treatment zone.
